(19) United States
(12) Patent Application Publication
(10) Pub. No.: US 2015/0153872 A1
(43) Pub. Date: Jun. 4, 2015

(54) TOUCH SENSING DEVICE

(71) Applicant: HIMAX TECHNOLOGIES LIMITED, Tainan City (TW)

(72) Inventors: Chia-Wei Hu, Tainan City (TW); Shen-Feng Tai, Tainan City (TW); Wai-Pan Wu, Tainan City (TW); Chia-Ling Lo, Tainan City (TW); Jui-Ni Li, Tainan City (TW)

(73) Assignee: HIMAX TECHNOLOGIES LIMITED, Tainan City (TW)

(21) Appl. No.: 14/210,462

(22) Filed: Mar. 14, 2014

Related U.S. Application Data
(60) Provisional application No. 61/910,968, filed on Dec. 3, 2013.

(51) Int. Cl. G06F 3/044

(52) U.S. Cl. CPC G06F 3/044

(57) ABSTRACT

A touch sensing device including a plurality of first sensing electrode sets, a plurality of first conductive lines, and a plurality of sensing sets is provided. The first sensing electrode sets are arranged in an array. The first conductive lines are respectively connected to the first sensing electrode sets. The sensing sets are capacitively coupled to the first sensing electrode sets. Each of the first sensing electrode sets is capacitively coupled to at least two of the sensing sets. One of each of the first sensing electrode sets and each of the sensing sets is a signal transmitter, and the other of each of the first sensing electrode sets and each of the sensing sets is a signal receiver.

### CROSS-REFERENCE TO RELATED APPLICATION

This application claims the priority benefits of U.S. provisional application Ser. No. 61/910,968, filed on Dec. 3, 2013. The entirety of the above-mentioned patent application is hereby incorporated by reference herein and made a part of this specification.

### BACKGROUND OF THE INVENTION

1. Field of the Invention

The invention generally relates to a sensing device and, in particular, to a touch sensing device.

2. Description of Related Art

There are many kinds of input interfaces, for example, a mouse, a keyboard, buttons, and a touch panel, to control electronic devices. The operation method of the touch panel is easier and more intuitive than other input interfaces, so that the touch panel is widely used in various kinds of electronic devices. Recently, the touch screen becomes the mainstream of the input interface of a portable electronic device, such as a smartphone, a tablet computer, or a notebook computer.

The touch panel may be classified into a capacitive touch panel, a resistive touch panel, an optical touch panel, etc. The capacitive touch panel has high sensitivity and high accuracy and is thus widely used in the portable electronic devices such as the smartphone and the tablet computer. A conventional touch panel includes two conductive layers to respectively form x-direction electrode strings and y-direction electrode strings perpendicular to the x-direction electrode strings. However, the cost of the touch panel with two conductive layers is hard to reduce.

Another conventional capacitance touch panel adopts a single conductive layer with a plurality of transmitting electrodes, a plurality of receiving electrodes, a plurality of transmitting wires, and a plurality of receiving wires. However, the total number of the transmitting wires and the receiving wires of the conventional single-layer capacitance touch panel is too large to further reduce the cost of the touch panel.

### SUMMARY OF THE INVENTION

Accordingly, the invention is directed to a touch sensing device, in which the number of conductive lines is reduced.

According to an embodiment of the invention, a touch sensing device including a plurality of first sensing electrode sets, a plurality of first conductive lines, and a plurality of sensing sets is provided. The first sensing electrode sets are arranged in an array. The first conductive lines are respectively connected to the first sensing electrode sets. The sensing sets are capacitively coupled to the first sensing electrode sets. Each of the first sensing electrode sets is capacitively coupled to at least two of the sensing sets. One of each of the first sensing electrode sets and each of the sensing sets is a signal transmitter, and the other of each of the first sensing electrode sets and each of the sensing sets is a signal receiver.

In the touch sensing device according to the embodiments of the invention, each of the first sensing electrode sets is capacitively coupled to at least two of the sensing sets, so that the touch sensing device has less conductive lines. As a result, the structure of the touch sensing device is simple, so as to reduce the cost of the touch sensing device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic bottom view of a touch sensing device according to an embodiment of the invention.

FIG. 1B is the enlarged view of the region M in FIG. 1A.

FIG. 2 is a schematic bottom view of a touch sensing device according to the comparative embodiment.

FIG. 3 is a schematic bottom view of a touch sensing device according to another embodiment of the invention.

FIG. 4 is a schematic bottom view of a touch sensing device according to another embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

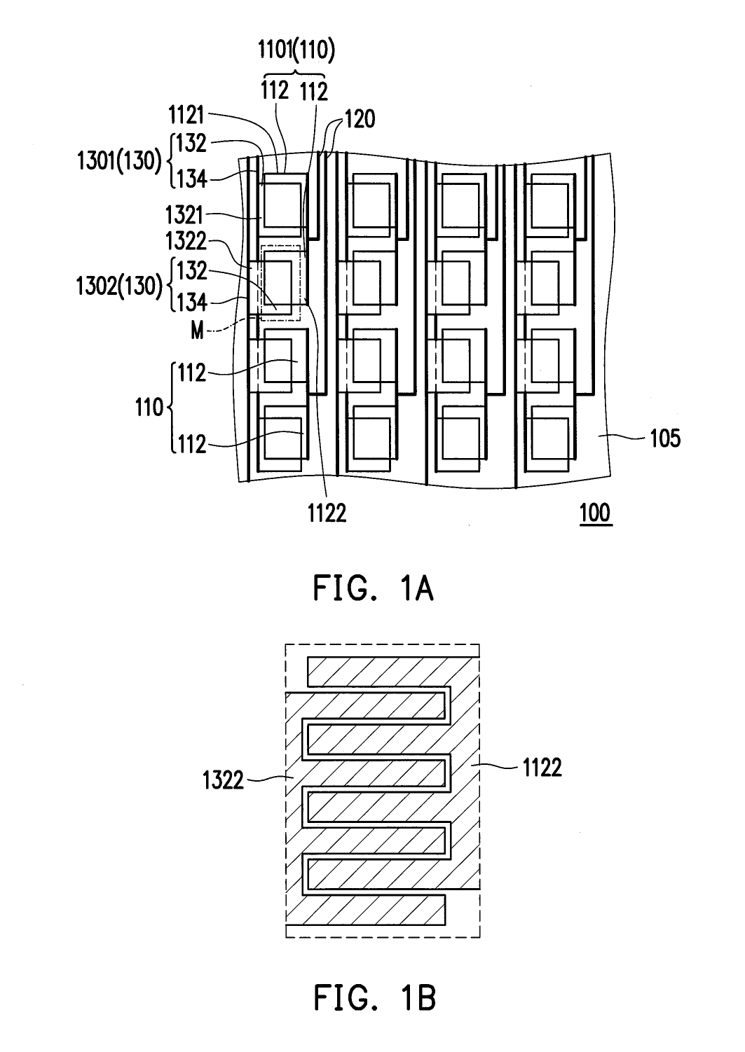

FIG. 1A is a schematic bottom view of a touch sensing device according to an embodiment of the invention, and FIG. 1B is the enlarged view of the region M in FIG. 1A. Referring to FIGS. 1A and 1B, the touch sensing device 100 in this embodiment includes a plurality of first sensing electrode sets 110, a plurality of first conductive lines 120, and a plurality of sensing sets 130. In this embodiment, the touch sensing device 100 includes a substrate 105, and the first sensing electrode sets 110, the first conductive lines 120, and the sensing sets 130 are formed on the substrate 150. The substrate 105 is, for example, a glass substrate, a plastic substrate, a flexible substrate, or a substrate mad of any other appropriate material.

The first sensing electrode sets 110 are arranged in an array. The first conductive lines 120 are respectively connected to the first sensing electrode sets 110. The sensing sets 130 are capacitively coupled to the first sensing electrode sets 110. Each of the first sensing electrode sets 110 is capacitively coupled to at least two of the sensing sets 130 (two are exemplarily shown in FIG. 1A). In this embodiment, each of the first sensing electrode sets 110 includes a plurality of first sensing electrodes 112 respectively capacitively coupled to the at least two of the sensing sets 130. In FIG. 1A, each of the first sensing electrode sets 110 includes two first sensing electrodes 112 respectively capacitively coupled to two of the sensing sets 130.

In this embodiment, each of the sensing sets 130 includes a second conductive line 134 and a plurality of second sensing electrodes 132. The second sensing electrodes 132 are connected to the second conductive line 134. The first sensing electrodes 112 of each of the first sensing electrode sets 110 are respectively capacitively coupled to some of the second sensing electrodes 132 belonging to different sensing sets 130. For example, the first sensing electrode 1121 is capacitively coupled to the second sensing electrode 1321 belonging to the sensing set 1301, and the first sensing electrode 1122 is capacitively coupled to the second sensing electrode 1322 belonging to the sensing set 1302, wherein the first sensing electrode 1121 and the first sensing electrode 1122 belongs to the same first sensing electrode set 1101.

One of each of the first sensing electrode sets 110 and each of the sensing sets 130 is a signal transmitter, and the other of each of the first sensing electrode sets 110 and each of the sensing sets 130 is a signal receiver. In this embodiment, the sensing sets 130 are signal transmitters, and the first sensing electrode sets 110 are signal receivers.

In this embodiment, the first sensing electrodes 112 are adjacent to the corresponding second sensing electrodes 132, and the first sensing electrodes 112 and the corresponding second sensing electrodes 132 are spaced apart. As a result, the first sensing electrodes 112 are capacitively coupled to the corresponding second sensing electrodes 132.

In this embodiment, the first sensing electrode sets 110, the first conductive lines 120, and the sensing sets 130 are formed with a single conductive layer. Although the second sensing electrodes 132 seem to overlap the corresponding first sensing electrodes 112, the second sensing electrodes 132 do actually not overlap the corresponding first sensing electrodes 112. In fact, the second sensing electrode 132 and the corresponding first sensing electrode 112 are complementary in shape and fill the overlap region schematically shown by FIG. 1A. Similarly, in other figures of the embodiments of the invention, the overlap regions of the corresponding electrodes mean that the corresponding electrodes are complementary in shape and fill the overlap region but do not overlap each other. Therefore, the electrodes (including the first sensing electrodes 112 and the second sensing electrodes 132) may be formed with a single conductive layer. In this embodiment, the single conductive layer is a transparent conductive layer. For example, the single conductive layer is made of indium tin oxide (ITO) or any other transparent conductive material.

In this embodiment, two first sensing electrodes 112 are connected to one receiver line (i.e. the first conductive lines 120), and the two first sensing electrodes 112 connected to the same signal receiver line are respectively capacitively coupled to two second sensing electrodes 132 respectively connected to two different signal transmitter lines (i.e. the second conductive line 134). The signal transmitter lines may be driven in sequence, and the signals from the signal receiver lines are received and detected simultaneously. As a result, an integrated circuit connected to the signal transmitter lines and the signal receiver lines may determine which one of the two first sensing electrodes 112 is touched by determine which one of the transmitter lines is driven. In this way, the total number of the signal transmitter lines and the signal receiver lines may be reduced.

For describing how the total number of the signal transmitter lines and the signal receiver lines is reduced, a comparative embodiment is provided.

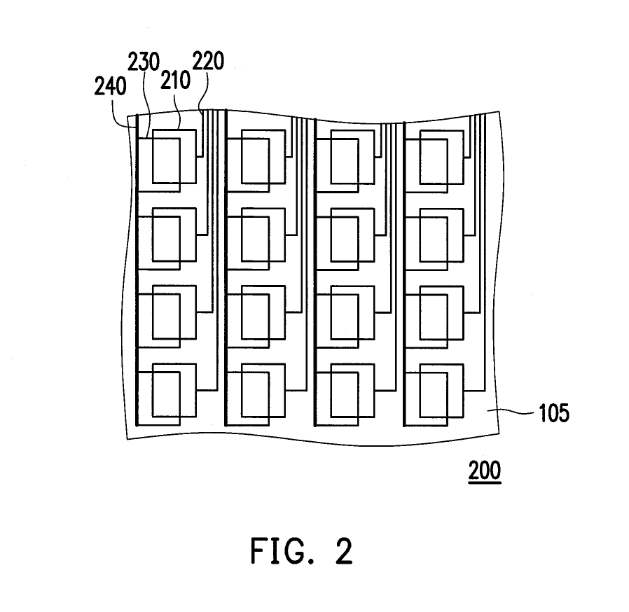

FIG. 2 is a schematic bottom view of a touch sensing device according to the comparative embodiment. Referring to FIG. 2, the touch sensing device 200 in the comparative embodiment includes a plurality of receiver electrodes 210, a plurality of receiver conductive lines 220, a plurality of transmitter electrodes 230, and a plurality of transmitter conductive lines 240. The receiver electrodes 210 are respectively connected to the receiver conductive lines 220 in a one-to-one manner, and each column of the transmitter electrodes 230 are connected to the same transmitter conductive line 240. For a 4×4 touch sensing regions, the total number of the transmitter conductive lines 240 and the receiver conductive lines 220 in the comparative embodiment are 4×4+4=20. However, for a 4×4 touch sensing regions, the total number of the first conductive lines 120 and the second conductive lines 134 in the touch sensing device 100 in FIG. 1A are 2×4+2×4=16. As a result, the touch sensing device 100 in FIG. 1A has less conductive lines, so that the structure of the touch sensing device 100 is simple, so as to reduce the cost of the touch sensing device 100. In addition, for 12×24 touch sensing regions, the total number of the transmitter conductive lines 240 and the receiver conductive lines 220 in the comparative embodiment are 24×12+12=300, while the total number of the first conductive lines 120 and the second conductive lines 134 in the touch sensing device 100 in FIG. 1A are 12×12+2×12=168. Therefore, the more the touch sensing regions, the less the total number of the conductive lines of the touch sensing device 100, and thus the simpler the touch sensing device 100.

In the touch sensing device 100, each of the first sensing electrode sets 110 is capacitively coupled to at least two of the sensing sets 130, so that the touch sensing device 100 has less conductive lines. As a result, the structure of the touch sensing device 100 is simple, so as to reduce the cost of the touch sensing device 100.

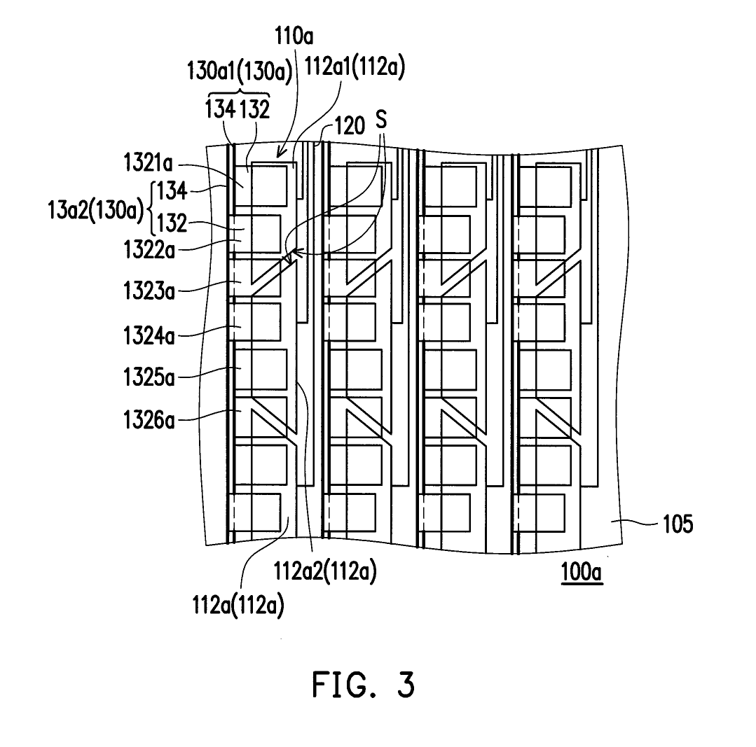

FIG. 3 is a schematic bottom view of a touch sensing device according to another embodiment of the invention. Referring to FIG. 3, the touch sensing device 100a in this embodiment is similar to the touch sensing device 100 in FIG. 1A, and the main difference therebetween is as follows. In the touch sensing device 100a, each of the first sensing electrode sets 110a includes a first sensing electrode 112a, each of the first sensing electrodes 112a is capacitively coupled to some of the second sensing electrodes 132 belonging to different sensing sets 130a, and at least one of the second sensing electrodes 132 is capacitively coupled to two adjacent first sensing electrodes 112a. For example, the first sensing electrode 112a1 is capacitively coupled to the second sensing electrode 1321a belonging to the sensing set 130a1 and coupled to the second sensing electrodes 1322a and 1323a belong to the sensing set 130a2. Moreover, the first sensing electrode 112a2 is capacitively coupled to the second sensing electrodes 1323a and 1324a belonging to the sensing set 130a2 and coupled to the second sensing electrodes 1325a and 1326a belong to the sensing set 130a1. Besides, the second sensing electrode 1323a is capacitively coupled to two adjacent first sensing electrodes 112a1 and 112a2, and the second sensing electrode 1326a is capacitively coupled to two adjacent first sensing electrodes 112a2 and 112a3. Two adjacent first sensing electrodes 112a respectively have inclined sides S parallel to each other, so that when the second sensing electrode 132a is touched, the touch position may be determined according to the proportion of the signals from the first sensing electrodes 112a1 and 112a2.

For 4×8 touch sensing regions, the total number of the first conductive lines 120 and the second conductive lines 134 in the touch sensing device 100a are 3×4+2×4=20. However, for 4×8 touch sensing regions, the total number of the transmitter conductive lines 240 and the receiver conductive lines 220 in the comparative embodiment are 8×4+4=36. For 12×24 touch sensing regions, the total number of the first conductive lines 120 and the second conductive lines 134 in the touch sensing device 100a are 8×12+2×12=120. However, for 12×24 touch sensing regions, the total number of the transmitter conductive lines 240 and the receiver conductive lines 220 in the comparative embodiment are 24×12+12=300. As a result, the total number of the conductive lines of the touch sensing device 100a is effectively reduced.

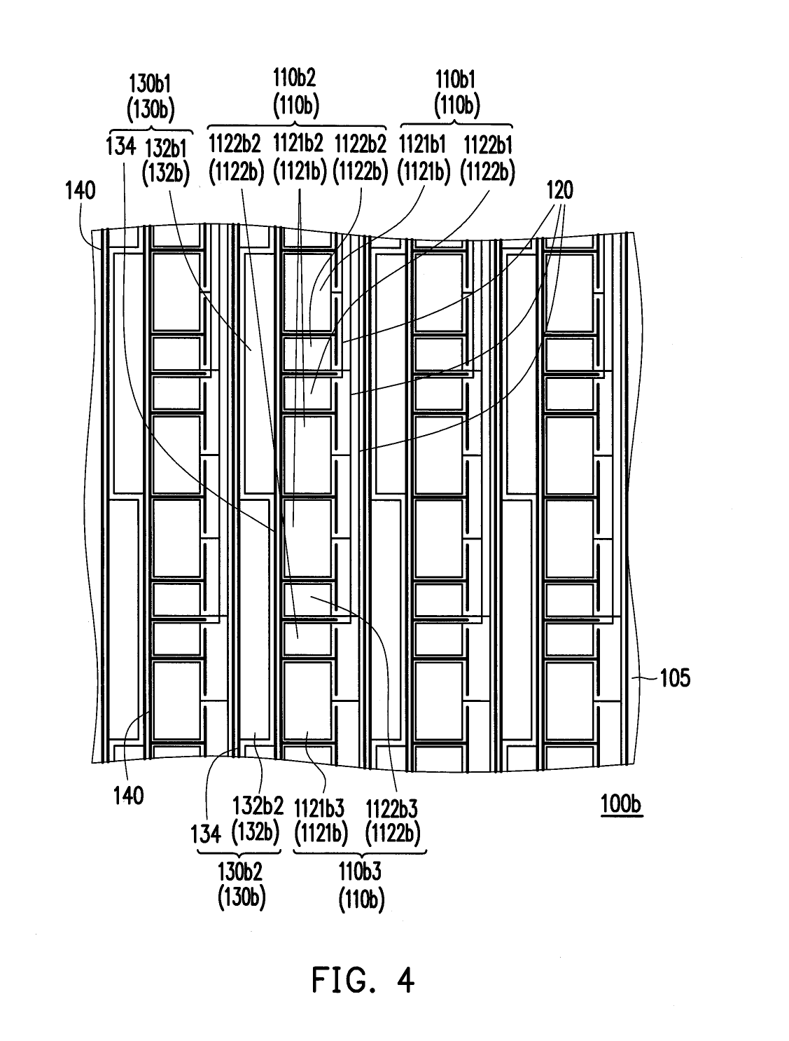

FIG. 4 is a schematic bottom view of a touch sensing device according to another embodiment of the invention. Referring to FIG. 4, the touch sensing device 100b in this embodiment is similar to the touch sensing device 100 in FIG. 1A, and the main difference therebetween is as follows. In the touch sensing device 100b, each of the first sensing electrode sets 110b includes at least one main sensing electrode 1121b and at least one appended sensing electrode 1122b, the appended sensing electrode 1122b of each of the first sensing electrode sets 110b is located between the main sensing electrode 1121b of an adjacent first sensing electrode set 110b and the appended sensing electrode 1122b of the adjacent first sensing electrode 110b. For example, the appended sensing electrode 1122b1 of the first sensing electrode set 110b1 is located between the upper main sensing electrode 1121b2 and the upper appended sensing electrode 1122b2 of the first sensing electrode set 110b2; the upper appended sensing electrode 1122b2 of the first sensing electrode set 110b2 is located between the main sensing electrode 1121b1 and the appended sensing electrode 1122b1 of the first sensing electrode set 110b1; the lower appended sensing electrode 1122b2 of the first sensing electrode set 110b2 is located between the main sensing electrode 1121b3 and the appended sensing electrode 1122b3 of the first sensing electrode set 110b3; the appended sensing electrode 1122b3 of the first sensing electrode set 110b1 is located between the upper main sensing electrode 1121b2 and the upper appended sensing electrode 1122b2 of the first sensing electrode set 110b2.

In addition, each of the second sensing electrodes 132b is capacitively coupled to two adjacent first sensing electrode sets 110b, and each of the second sensing electrodes 132b of each sensing set 130b and adjacent one of the second sensing electrodes 132b of another sensing set 130b are capacitively coupled to a same first sensing electrode set 110b. For example, the second sensing electrode 132b1 is disposed beside the first sensing electrode set 110b1 and the first sensing electrode set 110b2, and the second sensing electrode 132b1 of the sensing set 130b1 and the second sensing electrode 132b2 of the sensing set 130b2 are disposed beside a same first sensing electrode set 110b2.

For 12×24 touch sensing regions, the total number of the first conductive lines 120 and the second conductive lines 134 in the touch sensing device 100b are 9×12+2×12=132. However, for 12×24 touch sensing regions, the total number of the transmitter conductive lines 240 and the receiver conductive lines 220 in the comparative embodiment are 24×12+12=300. As a result, the total number of the conductive lines of the touch sensing device 100b is effectively reduced.

In this embodiment, the touch sensing device 100b further includes a plurality of ground lines 140 extending between the main sensing electrodes 1121b, the appended sensing electrodes 1122b, and the second sensing electrodes 132b.

Compared with the comparative embodiment, the more the touch sensing regions, the more the total number of the conductive lines of the touch sensing device 100, 100a, 100b is reduced. As a result, when the touch sensing device 100, 100a, 100b is used in a large size display, the reduction of the total number of the conductive lines is more significant. When the number of the touch sensing regions is large, the total numbers of the conductive lines of the comparative embodiment, the touch sensing device 100, and the touch sensing device 100a (or 100b) are approximately M×N, 0.5×M×N, and 0.33×M×N, respectively.

The touch sensing device 100, 100a, 100b may be used in an on-glass solution or in-cell solution, or used as a glass sensor, a glass and film sensor, or an on-cell sensor.

In the touch sensing device according to the embodiments of the invention, each of the first sensing electrode sets is capacitively coupled to at least two of the sensing sets, so that the touch sensing device has less conductive lines. As a result, the structure of the touch sensing device is simple, so as to reduce the cost of the touch sensing device.

It will be apparent to those skilled in the art that various modifications and variations can be made to the structure of the invention without departing from the scope or spirit of the invention. In view of the foregoing, it is intended that the invention covers modifications and variations of this invention provided they fall within the scope of the following claims and their equivalents.

What is claimed is:

1. A touch sensing device comprising:
a plurality of first sensing electrode sets arranged in an array;
a plurality of first conductive lines respectively connected to the first sensing electrode sets; and
a plurality of sensing sets capacitively coupled to the first sensing electrode sets, wherein each of the first sensing electrode sets is capacitively coupled to at least two of the sensing sets, one of each of the first sensing electrode sets and each of the sensing sets is a signal transmitter, and the other of each of the first sensing electrode sets and each of the sensing sets is a signal receiver.

2. The touch sensing device according to claim 1, wherein each of the first sensing electrode sets comprises a plurality of first sensing electrodes respectively capacitively coupled to the at least two of the sensing sets.

3. The touch sensing device according to claim 2, wherein each of the sensing sets comprises:
a second conductive line; and
a plurality of second sensing electrodes connected to the second conductive line, wherein the first sensing electrodes of each of the first sensing electrode sets are respectively capacitively coupled to some of the second sensing electrodes belonging to different sensing sets.

4. The touch sensing device according to claim 3, wherein the first sensing electrodes are adjacent to the corresponding second sensing electrodes, and the first sensing electrodes and the corresponding second sensing electrodes are spaced apart.

5. The touch sensing device according to claim 1, wherein each of the first sensing electrode sets comprises a first sensing electrode, and each of the sensing sets comprises:
a second conductive line; and
a plurality of second sensing electrodes connected to the second conductive line, wherein each of the first sensing electrode sets comprises a first sensing electrode, each of the first sensing electrodes is capacitively coupled to some of the second sensing electrodes belonging to different sensing sets, and at least one of the second sensing electrodes is capacitively coupled to two adjacent first sensing electrodes.

6. The touch sensing device according to claim 1, wherein each of the first sensing electrode sets comprises at least one main sensing electrode and at least one appended sensing electrode, the appended sensing electrode of each of the first sensing electrode sets is located between the main sensing electrode of an adjacent first sensing electrode set and the appended sensing electrode of the adjacent first sensing electrode set, and each of the sensing sets comprises:
a second conductive line; and
a plurality of second sensing electrodes connected to the second conductive line, wherein each of the second sensing electrodes is capacitively coupled to two adjacent first sensing electrode sets, and each of the second sensing electrodes of each sensing set and adjacent one of the second sensing electrodes of another sensing set are capacitively coupled to a same first sensing electrode set.

7. The touch sensing device according to claim 1, wherein the first sensing electrode sets, the first conductive lines, and the sensing sets are formed with a single conductive layer.

8. The touch sensing device according to claim 7, wherein the single conductive layer is a transparent conductive layer.
